(19) United States
(12) Patent Application Publication
(10) Pub. No.: US 2022/0245440 A1
(43) Pub. Date: Aug. 4, 2022

(54) TRIPLET GENERATION FOR REPRESENTATION LEARNING IN TIME SERIES USING DISTANCE BASED SIMILARITY SEARCH

(71) Applicant: International Business Machines Corporation, Armonk, NY (US)

(72) Inventors: Dharmashankar Subramanian, White Plains, NY (US); Venkata Nagaraju Pavuluri, New Rochelle, NY (US); Yuan-Chi Chang, Armonk, NY (US); Long Vu, Chappaqua, NY (US); Timothy Rea Dinger, Croton-on-Hudson, NY (US)

(21) Appl. No.: 17/162,626

(22) Filed: Jan. 29, 2021

(51) Int. Cl. G06N 3/08; G06K 9/62; G06F 9/38

(52) U.S. Cl. CPC G06N 3/08; G06F 9/3836; G06K 9/6259

(57) ABSTRACT

A method of using a computing device to train a neural network to recognize features in variate time series data that includes receiving, by a computing device, variate time series data. The computing device further receives results associated with the variate time series data. The computing device determines an anchor of the variate time series data. The computing device additionally determines one or more portions of the variate time series data which lead to a positive result. The computing device further determines one or more portions of the variate time series data which lead to a negative result. The computing device trains a neural network to interpret results of future variate time series data based upon the anchor, the one or more portions of the variate time series data which lead to the positive result, and the one or more portions of the variate time series data which lead to the negative result.

### BACKGROUND

The field of embodiments of the present invention relates to using a computing device to train a neural network to recognize features in unvariate or multivariate time series data.

Representation learning has proven effective for learning essential features that capture the salient characteristics of data in many domains. Specifically, triple-loss based representation learning involves a “triplet loss,” namely a loss function for artificial neural networks where a baseline (anchor) input is compared to a positive (truth-like) input and a negative (false-like) input, and the representation is learned such that the distance from the baseline (anchor) input to the positive (truth-like) input is minimized in the representation space, and the distance from the baseline (anchor) input to the negative (false-like) input is maximized (in the representation space).

Conventional state of the art time series representation learning (RL) follows a dilated temporal convolutional neural network (CNN) architecture with triplet loss, where anchor windows are chosen randomly in position and size, positive samples are randomly chosen within the anchor windows, and negative samples are randomly chosen outside the anchor windows. While random positives/negatives allow for easy assembly of triplets, the conventional time series RL only emphasize self-similarity in selecting positives, and leave dissimilarity negatives completely to chance.

### SUMMARY

Embodiments relate to using a computing device to train a neural network (NN) to recognize features in unvariate or multivariate time series data. One embodiment provides a method of using a computing device to train a NN to recognize features in variate time series data that includes receiving, by a computing device, variate time series data. The computing device further receives results associated with the variate time series data. The computing device determines an anchor of the variate time series data. The computing device additionally determines one or more portions of the variate time series data which lead to a positive result. The computing device further determines one or more portions of the variate time series data which lead to a negative result. The computing device trains a NN to interpret results of future variate time series data based upon the anchor, the one or more portions of the variate time series data which lead to the positive result, and the one or more portions of the variate time series data which lead to the negative result. Some features contribute to the advantage of providing for positive and negative sample selection for triplet training, by incorporating similarity search for the selection process. Other features contribute to the advantage for an unsupervised (label-unaware) machine learning (ML) model to process a positive and negative universe for similarity sample selection that is chosen at random; and the positive and negative samples are obtained through a similarity search within these two sets. Some features contribute to the advantage that an original triple loss function that uses a single (self-sub-sampled) positive sample is modified to a more general case of multiple positive samples, which are also not restricted to be self-sub-sampled.

One or more of the following features may be included. In some embodiments, the method may further include that the variate time series data is univariate time series data or multivariate time series data.

In some embodiments, the method may additionally include that the neural network is further trained to represent any portion of the time series data based upon one or more combinations of the anchor, the one or more portions of the variate time series data which lead to the positive result, the one or more portions of the variate time series data which lead to the negative result.

In one or more embodiments, the method may further include that one or more distances between the one or more portions of the variate time series data which leads to the positive result, the one or more portions of the variate time series data which lead to the negative result, and the anchor is used in training the NN.

In some embodiments, the method may additionally include that determining the anchor includes a selection of a random sub-interval of a corresponding length for each variate time series data object in a training batch of multiple variate time series data objects.

In one or more embodiments, the method may include that determining the anchor includes selection of a local variance based selection protocol that systematically sweeps through the variate time series data in entirety and produces a sequence of anchors, selected one at a time across batches, for each variate time series object included in a training batch of multiple variate time series data objects.

In some embodiments, the method may further include that the positive result and the negative result are determined using a random selection protocol which selects variate time series object indices randomly with replacement from a set of all variate time series data objects available for training.

In one or more embodiments, the method may further include that the positive result is determined using a label-aware random selection protocol, which uses a restricted set of those variate time series object indices whose labels match a label of the variate time series data object from which the anchor is determined, and performs a random selection with replacement from the restricted set; and the negative result is determined using a label-aware random selection protocol, which uses a restricted set of those variate time series object indices whose labels do not match a label of the variate time series data object from which the anchor is determined, and that performs a random selection with replacement from the restricted set.

These and other features, aspects and advantages of the present embodiments will become understood with reference to the following description, appended claims and accompanying figures.

### BRIEF DESCRIPTION OF THE DRAWINGS

FIG. 1 shows a flow diagram for unsupervised (label-unaware) machine learning processing, according to one embodiment;

FIG. 2 shows a flow diagram for supervised (label-aware) machine learning processing, according to one embodiment;

FIG. 3 shows a computing process for similarity-based mining of positive and negative samples for each anchor, according to one embodiment;

FIG. 4 illustrates a block diagram of a process for using a computing device to train a NN to recognize features in univariate or multivariate time series data, according to one embodiment;

FIG. 5 depicts a cloud computing environment, according to an embodiment;

FIG. 6 depicts a set of abstraction model layers, according to an embodiment;

FIG. 7 is a network architecture of a system for training a NN to recognize features in univariate or multivariate time series data, according to an embodiment;

FIG. 8 shows a representative hardware environment that may be associated with the servers and/or clients of FIG. 5, according to an embodiment; and

FIG. 9 is a block diagram illustrating a distributed system for training a NN to recognize features in univariate or multivariate time series data, according to one embodiment.

### DETAILED DESCRIPTION

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments relate to using a computing device to train a NN to recognize features in unvariate or multivariate time series data. One embodiment provides a method of using a computing device to train a NN to recognize features in variate time series data that includes receiving, by a computing device, variate time series data. The computing device further receives results associated with the variate time series data. The computing device determines an anchor of the variate time series data. The computing device additionally determines one or more portions of the variate time series data which lead to a positive result. The computing device further determines one or more portions of the variate time series data which lead to a negative result. The computing device trains a NN to interpret results of future variate time series data based upon the anchor, the one or more portions of the variate time series data which lead to the positive result, and the one or more portions of the variate time series data which lead to the negative result. Some features contribute to the advantage of providing for positive and negative sample selection for triplet training, by incorporating similarity search for the selection process. Other features contribute to the advantage for an unsupervised (label-unaware) machine learning (ML) model to process a positive and negative universe for similarity sample selection that is chosen at random; and the positive and negative samples are obtained through a similarity search within these two sets. Some features contribute to the advantage that an original triple loss function that uses a single (self-sub-sampled) positive sample is modified to a more general case of multiple positive samples, which are also not restricted to be self-sub-sampled.

In some embodiments, the method may further include that the variate time series data is univariate time series data or multivariate time series data.

In one or more embodiments, the method may further include that the neural network is further trained to represent any portion of the time series data based upon one or more combinations of the anchor, the one or more portions of the variate time series data which lead to the positive result, the one or more portions of the variate time series data which lead to the negative result.

In some embodiments, the method may additionally include that one or more distances between the one or more portions of the variate time series data which leads to the positive result, the one or more portions of the variate time series data which lead to the negative result, and the anchor is used in training the NN.

In some embodiments, the method may additionally include that determining the anchor includes a selection of a random sub-interval of a corresponding length for each variate time series data object in a training batch of multiple variate time series data objects.

In one or more embodiments, the method may include that determining the anchor includes selection of a local variance based selection protocol that systematically sweeps through the variate time series data in entirety and produces a sequence of anchors, selected one at a time across batches, for each variate time series object included in a training batch of multiple variate time series data objects.

In some embodiments, the method may further include that the positive result and the negative result are determined using a random selection protocol which selects variate time series object indices randomly with replacement from a set of all variate time series data objects available for training.

In some embodiments, the method may further include that the positive result is determined using a label-aware random selection protocol, which uses a restricted set of those variate time series object indices whose labels match a label of the variate time series data object from which the anchor is determined, and performs a random selection with replacement from the restricted set; and the negative result is determined using a label-aware random selection protocol, which uses a restricted set of those variate time series object indices whose labels do not match a label of the variate time series data object from which the anchor is determined, and that performs a random selection with replacement from the restricted set.

One or more embodiments include a model for processing (e.g., for process 100, process 200, process 300, etc.) that employs one or more artificial intelligence (AI) models. AI models may include a trained ML model (e.g., models, such as a NN, a convolutional NN (CNN), a recurrent NN (RNN), a Long short-term memory (LSTM) based NN, gate recurrent unit (GRU) based RNN, tree-based CNN, a self-attention network (e.g., a NN that utilizes the attention mechanism as the basic building block; self-attention networks have been shown to be effective for sequence modeling tasks, while having no recurrence or convolutions), BiLSTM (bi-directional LSTM), etc.). An artificial NN is an interconnected group of nodes or neurons.

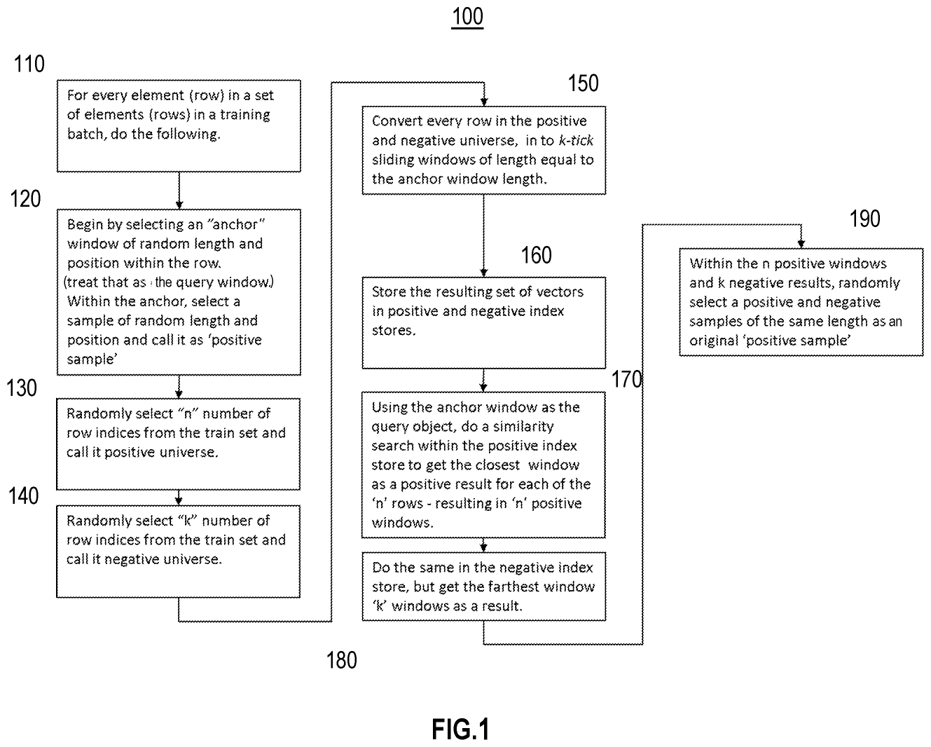

FIG. 1 shows a flow diagram for unsupervised (label-unaware) ML model processing 100, according to one embodiment. In one embodiment, the ML model processing 100 provides for generating positive and negative samples in triplet loss formulation of feature representation learning of univariate time series data. Existing approaches seek to fit image-based triplet generation to time series, such as cropping/cutting/translating the anchor image (e.g., sub-sampling the anchor for positives), and choosing a random image (e.g., choosing a random time series interval for negatives). Unlike images, numerical time series offer more natural measures of similarity and contrast. One or more embodiments provide for positive and negative sample selection for triplet training, by incorporating similarity search for the selection process. In one embodiment, for the unsupervised (label-unaware) ML model processing 100, a positive and negative universe for similarity sample selection is chosen at random, and the positive and negative samples are obtained through a similarity search within these two sets. In one embodiment, for the unsupervised (label-unaware) ML model processing 100, a positive and negative universe for similarity sample selection is chosen using similarity and dissimilarity based on distance to the anchor time series object, and the positive and negative samples are obtained through a similarity search within these two sets. In one embodiment, an original triplet loss function that uses a single (self-sub-sampled) positive sample is modified to the more general case of multiple positive samples, which are also not restricted to be self-sub-sampled.

In one embodiment, a chosen distance is adapted to a multivariate time series. In a multivariate time series, each “window” or interval of data is a two-dimensional matrix, m×s, where m is the dimensionality of the time series, and s is the number of time-steps in the interval. Applying the vec( ) operator (an operator that transforms a matrix into a column vector by vertically stacking the columns of the matrix) flattens the matrix into a one-dimensional vector of size ms. In one embodiment, L2 (squared Euclidean that computes the length of a vector in Euclidean space) distances in a corresponding vector space of dimension ms. In another embodiment, weighted aggregation of component-wise one-dimensional distances are implemented over all components, and weighted using variance of each component's values over the “window.” In one embodiment, a graphical processing unit (GPU)-optimized library is implemented for computing k-nearest neighbors in dense vector spaces: an open source library for efficient similarity search and clustering of dense vectors is implemented (e.g., Faiss, etc.). In one embodiment, the ML processing 100 performs necessary memory and run-time optimizations to make the computational overhead of distance-based positive and negative sample mining acceptable in practice. In one embodiment, Faiss index stores are precomputed for a set of anchor lengths (variance-based anchor selection, and resulting set of lengths that sweep and cover the entire time series).

In block 110, given a training set of N univariate time series objects, for every element (row) in a set of elements (row) in a ML training batch, processing blocks 120-190 are performed. In block 120, ML model processing 100 begins by selecting an “anchor” window of a random length and position within the row (treat that as the query window). Within the anchor, a sample of random length and position is selected and referred to as a positive universe. In one embodiment, the anchor is selected using a suitable selection protocol from each time series object in a training batch of multiple time series objects. In one embodiment, the selection protocol may include a selection of a random sub-interval of a corresponding length, for each time series object in a training batch of multiple time series objects. In some embodiments, the anchor selection includes using a local variance based selection protocol that systematically sweeps through the entire time series and produces a sequence of anchor objects, chosen one at a time across batches, for each time series object included in a training batch of multiple time series objects.

In one embodiment, in block 130, ML model processing 100 randomly selects n number of row indices from the training set and refer to this as the positive universe. In one embodiment, in block 140, ML model processing 100 randomly selects k number of row indices from the training set and refer to this as the negative universe. In one embodiment, the size of positive or negative universe is a chosen number of corresponding positive or negative samples that are in correspondence with the anchor, and each element in the positive or negative universe is a particular time series object, such as an index i out of all the N time series objects available for training. In one embodiment, the selection of positive universe and negative universe is performed using a random selection protocol which selects time series object indices randomly with replacement from the set of all the N time series objects available for training. In one embodiment, the selection of the positive universe may be implemented by using a label-aware random selection protocol, which first restricts attention to only those time series object indices (from the set of all the N time series objects available for training) whose labels match the label of the time series object from which the anchor is selected in block 120, and then performs random selection with replacement from this restricted set. In another embodiment, the selection of the negative universe in block 120 is implemented using a label-aware random selection protocol, which first restricts attention to only those time series object indices (from the set of all the N time series objects available for training) whose labels disagree with the label of the time series object from which the anchor is selected, and then performs random selection with replacement from this restricted set.

In one embodiment, in block 150, the ML model processing 100 converts every row in the positive and negative universe into k-tick sliding windows of length equal to the anchor window length. In one embodiment, each time series object, i, in the positive (negative) universe, a set of intervals whose length is equal to the length of the selected anchor is selected, using a suitable selection protocol. Further, over the chosen set of such intervals, a time-series similarity/distance measure is used to determine the closest (farthest) interval to the selected anchor. In one embodiment, the selected set of intervals in each time series object from the positive (negative) universe is the set of all 1-tick sliding intervals whose length is the same as the length of the matching anchor. In one embodiment, the selected set of intervals in each time series object from the positive (negative) universe is the set of all k-tick sliding intervals whose length is the same as the length of the matching anchor. In another embodiment, the selected set of intervals in each time series object from the positive (negative) universe is the set of all k-tick sliding intervals whose length is the same as the length of the matching anchor, where k is chosen to be stratified, covering the entire time series, using a budget M for the number of such intervals. In one embodiment, the chosen set of intervals in each time series object from the positive (negative) universe is the set of budgeted M randomly selected intervals whose length is the same as the length of the matching anchor.

In one embodiment, in block 160 the ML model processing 100 stores the resulting set of vectors in positive and negative stores (e.g., a memory, etc.). In block 170, the ML model processing 100, using the anchor window as the query object, performs a similarity search within the positive index store to obtain the closest window as a positive result for each of the n rows-resulting in n positive windows. In one embodiment, the time series similarity measure is selected to be any of a Euclidean distance, squared Euclidean distance, dynamic time warping, cosine distance, inner product, Lp-Norm (for chosen p), Mahalanobis distance, Canberra distance, Bray-Curtis distance, Jensen-Shannon distance, or any combination thereof.

In one embodiment, in block 180 the ML model processing 100 performs similar processing as block 170 for the negative index store, but obtains the farthest window k windows as a result.

In one embodiment, in block 190 the ML model processing 100, within the n positive windows and k negative results, performs a random selection for positive and negative samples of the same length as an original positive sample. Processing of blocks 110-190 yields a selected anchor of a corresponding length, a set of positive intervals (one from each time series in the positive universe), and a set of negative intervals (one from each time series in the negative universe), which together form the triplet for a corresponding triplet loss function based feature-representation learning. In one embodiment, the resulting triplet is further randomly sub-sampled to a random sub-interval of a chosen length, i.e. each interval of the same length within {anchor, set of positive samples, set of negative samples} are further sub-sampled to corresponding random sub-intervals of a chosen length.

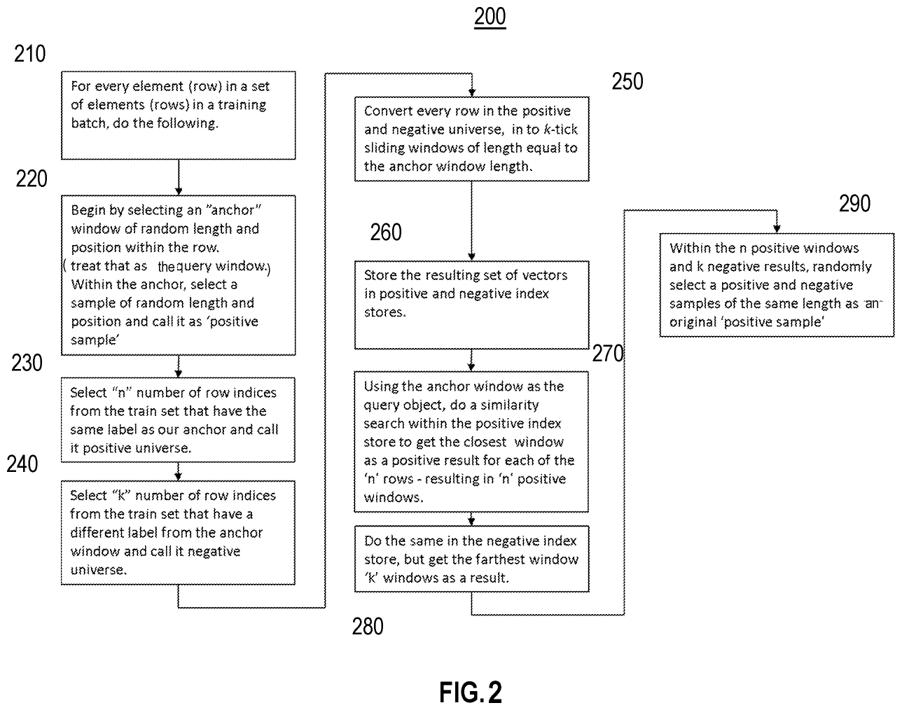

FIG. 2 shows a flow diagram for supervised (label-aware) ML processing 200, according to one embodiment. In one embodiment, the ML processing 200 provides for generating positive and negative samples in triplet loss formulation of feature representation learning of multivariate time series data. The ML processing 200 provides a label-aware (weakly supervised) process where positive and negative universe for similarity sample selection are selected by taking advantage of existing labels, and the positive and negative samples are obtained through similarity search within these two sets. In one embodiment, in block 210, given a training set of N multivariate time series objects, for every element (row) in a set of elements (row) in a ML training batch, processing blocks 220-290 are performed. In block 220, ML model processing 200 begins by selecting an anchor window of a random length and position within the row (treat that as the query window). Within the anchor, a sample of random length and position is selected and referred to as a positive universe. In one embodiment, the anchor is selected using a suitable selection protocol from each time series object in a training batch of multiple time series objects. In one embodiment, the selection protocol may include a selection of a random sub-interval of a corresponding length, for each time series object in a training batch of multiple time series objects. In one embodiment, the anchor selection is performed using a local aggregate variance (over all components) based selection protocol that systematically sweeps through the entire time series and produces a sequence of anchor objects, selected one at a time across batches, for each time series object included in a training batch of multiple time series objects.

In one embodiment, in block 230, ML model processing 200 randomly selects n number of row indices from the training set and refers to this as the positive universe. In one embodiment, in block 240, ML model processing 200 randomly selects k number of row indices from the training set that have a different label from the anchor window and refers to this as the negative universe. In one embodiment, the size of positive or negative universe is a chosen number of corresponding positive or negative samples that are in correspondence with the anchor, and each element in the positive or negative universe is a particular time series object, such as an index i out of all the N time series objects available for training. In one embodiment, the selection of positive universe and negative universe is performed using a random selection protocol which selects time series object indices randomly with replacement from the set of all the N time series objects available for training. In one embodiment, the selection of the positive universe may be implemented by using a label-aware random selection protocol, which first restricts attention to only those time series object indices (from the set of all the N time series objects available for training) whose labels match the label of the time series object from which the anchor is selected in block 220, and then performs random selection with replacement from this restricted set. In another embodiment, the selection of the negative universe in block 220 is implemented using a label-aware random selection protocol, which first restricts attention to only those time series object indices (from the set of all the N time series objects available for training) whose labels disagree with the label of the time series object from which the anchor is selected, and then performs random selection with replacement from this restricted set.

In one embodiment, in block 250, the ML model processing 200 converts every row in the positive and negative universe into k-tick sliding windows of length equal to the anchor window length. In one embodiment, each time series object, i, in the positive (negative) universe, a set of intervals whose length is equal to the length of the selected anchor is selected, using a suitable selection protocol. Further, over the chosen set of such intervals, a time-series similarity/distance measure is used to determine the closest (farthest) interval to the selected anchor. In one embodiment, the selected set of intervals in each time series object from the positive (negative) universe is the set of all 1-tick sliding intervals whose length is the same as the length of the matching anchor. In one embodiment, the selected set of intervals in each time series object from the positive (negative) universe is the set of all k-tick sliding intervals whose length is the same as the length of the matching anchor. In another embodiment, the selected set of intervals in each time series object from the positive (negative) universe is the set of all k-tick sliding intervals whose length is the same as the length of the matching anchor, where k is chosen to be stratified, covering the entire time series, using a budget M for the number of such intervals. In one embodiment, the chosen set of intervals in each time series object from the positive (negative) universe is the set of budgeted M randomly selected intervals whose length is the same as the length of the matching anchor. In one embodiment, the determination of similarity based positive and negative samples is implemented using GPU-optimized engines that compute k-nearest neighbors in dense vector spaces.

In one embodiment, in block 260 the ML model processing 200 stores the resulting set of vectors in positive and negative index stores. In block 270, the ML model processing 200, using the anchor window as the query object, performs a similarity search within the positive index store to obtain the closest window as a positive result for each of the n rows-resulting in n positive windows. In one embodiment, the similarity search is adapted to multivariate time series intervals by first using the vec( )operator to flatten the multivariate time series window into a one-dimensional vector, and applying a univariate time series similarity measure. In another embodiment, the similarity search in is adapted to multivariate time series intervals by first applying a univariate time series similarity measure for each component, and aggregating the set of resulting univariate component-wise similarity measures using a weighted additive aggregation. In one embodiment, the weighted additive aggregation uses the normalized variance (normalized across components) of each component time series in the anchor as the set of weights. In one embodiment, the time series similarity measure is selected to be any of a Euclidean distance, squared Euclidean distance, dynamic time warping, cosine distance, inner product, Lp-Norm (for chosen p), Mahalanobis distance, Canberra distance, Bray-Curtis distance, Jensen-Shannon distance, or any combination thereof.

In one embodiment, in block 280 the ML model processing 200 performs similar processing as block 270 for the negative index store, but obtains the farthest window k windows as a result.

In one embodiment, in block 290 the ML model processing 200, within the n positive windows and k negative results, performs a random selection for positive and negative samples of the same length as an original positive sample. Processing of blocks 210-290 yields a selected anchor of a corresponding length, a set of positive intervals (one from each time series in the positive universe), and a set of negative intervals (one from each time series in the negative universe), which together form the triplet for a corresponding triplet loss function based feature-representation learning. In one embodiment, the resulting triplet is further randomly sub-sampled to a random sub-interval of a chosen length, i.e. each interval of the same length within {anchor, set of positive samples, set of negative samples} are further sub-sampled to corresponding random sub-intervals of a chosen length.

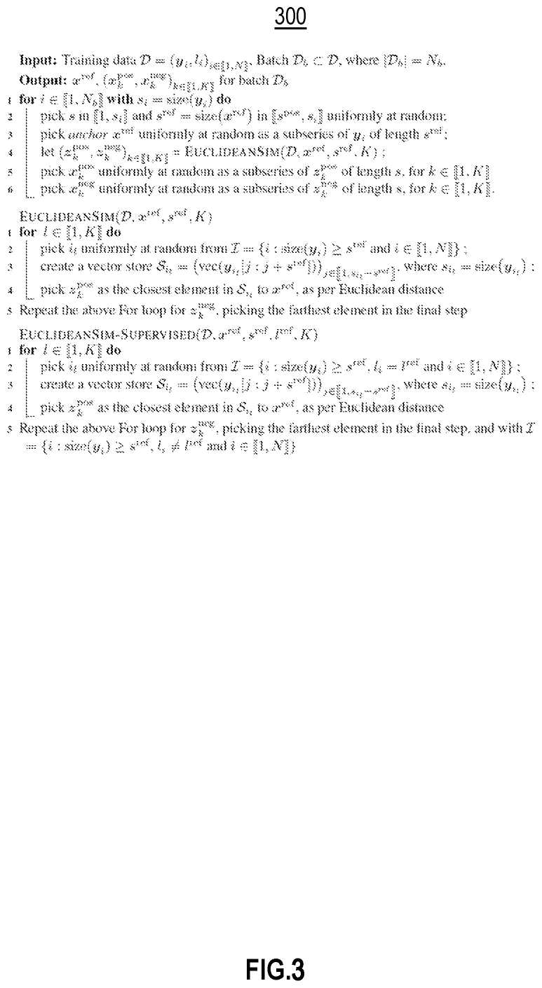

FIG. 3 shows a computing process (algorithm) 300 for similarity-based mining of positive and negative samples for each anchor, according to one embodiment. In one embodiment, the input for process 300 is the training data D and training batch D_{b}, and the output is the anchor (x^{ref}) of a corresponding length, and a set of positive (one from each time series in the positive universe) and negative (one from each time series in the negative universe) intervals (Xₖ^{pos},xₖ^{neg})_{k∈([[1,K]]} for batch D_{b}, which together form the triplet for a corresponding triplet loss function based feature-representation learning. For a chosen anchor object of length s, conventional processing techniques perform searching, exhaustively, over all 1-tick sliding windows of length s^{ref}, from each time series, i, in the positive universe and the negative universe, which can become prohibitive in very long time series. The number of such 1-tick sliding windows is O(sᵢ) in each time series, where sᵢ is the length of the time series i. Distinguishable, in one embodiment process 300 uses a predetermined budget, such as M number of windows to index for distance-based similarity. In on embodiment, the predetermined budge may be achieved using a k-tick sliding set of windows, where:

$$k = ⌈ \frac{( {s}_{i} - {s}^{ref} )}{M} ⌉ .$$

This leads to at most M such windows of length s, which are also stratified over the timeline with respect to coverage of the time series i.

In one embodiment, some advantages and benefits are that triple mining for process 300 exploits time series similarity and distance metrics, which prove effective for multivariate time series data sets as well as univariate data set. Some embodiments improve representation learning, especially for more difficult datasets, in accuracy maximum, average and range across training runs. In one embodiment, the process 300 exploits the numerical operations that are natural to time series, instead of force-fitting it to ideas from image processing. One embodiment provides distance based positive sample mining that is more robust than self-similarity/sub-sampling alone, and yields a richer set of similar time intervals. Distance based negative sample mining is more systematic than leaving it to chance (random sampling). In one embodiment, a practical benefit in ML automation reduces automation search time, reduces the number of representation learning execution to save compute time, provides a better confidence if learning execution needs to be stopped early, and provides a more sophisticated addition to a feature engineering toolbox. In one example embodiment, for multivariate time series data, one embodiment showed performance gains for mean (e.g., 3% increase over a baseline for labeled; 6% increase for non-label), range (e.g., 1% decrease over a baseline for labeled; 3.4% increase for non-label) and max (e.g., 3% increase over a baseline for labeled; 4.3% increase for non-label) criteria over conventional techniques. The process 300 similarity metric-based triplet generation and its extension to multivariate time series yields substantial performance gains for sweep criteria (e.g., 5 sole wins over a baseline of 1 for labeled; 2 sole wins over a baseline of 1 for non-labeled). One or more embodiments may be generalized to select anchors, positive and negative samples for representation learning based on training data statistics, and similarities or dissimilarities in waveform signatures and motifs.

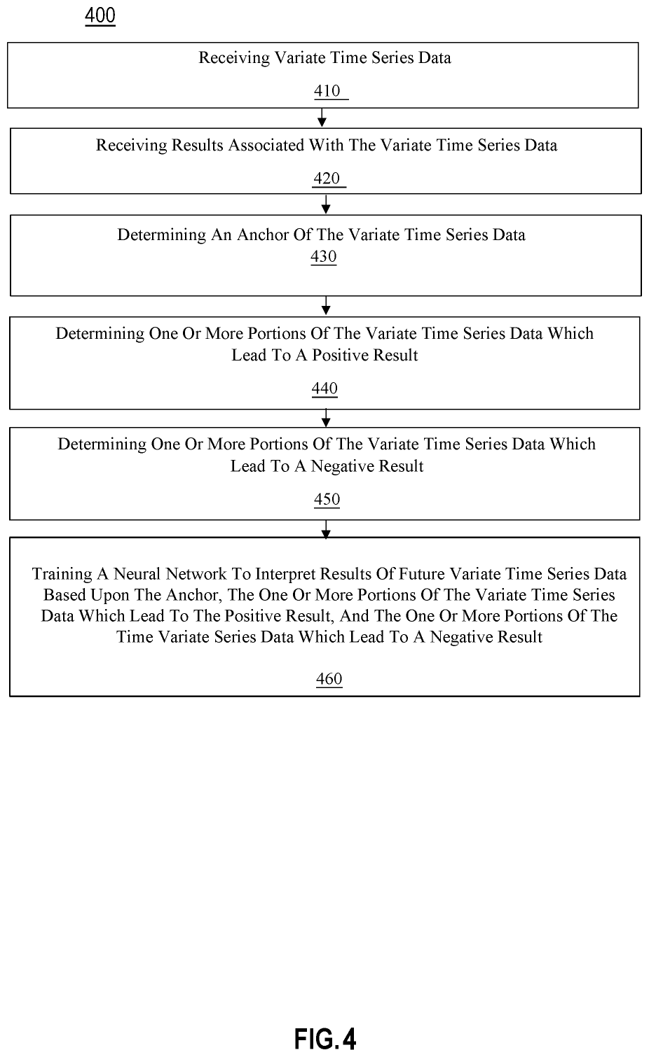

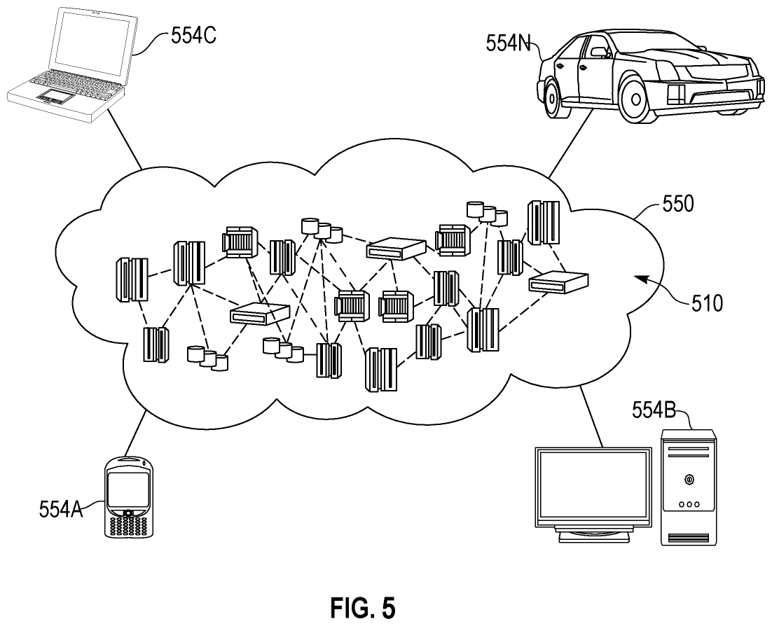

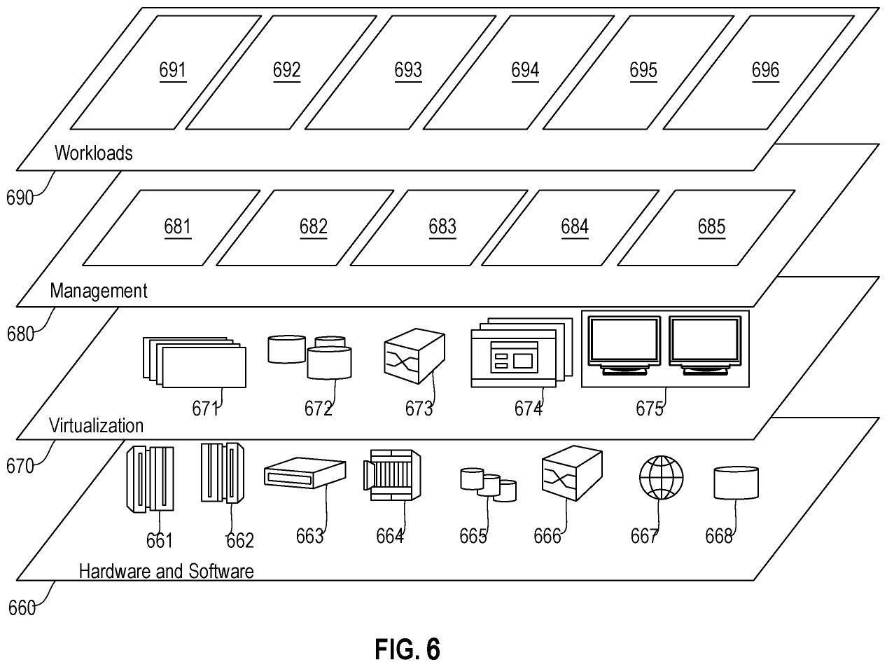

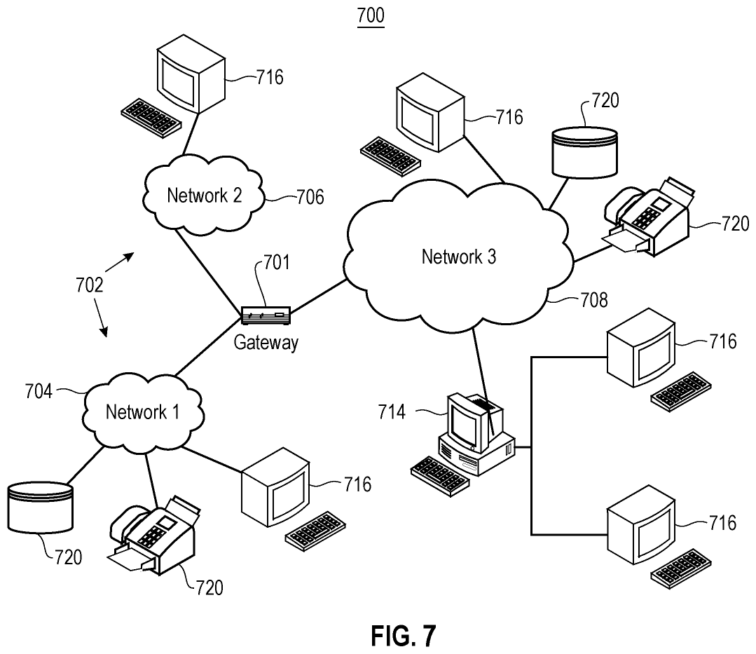

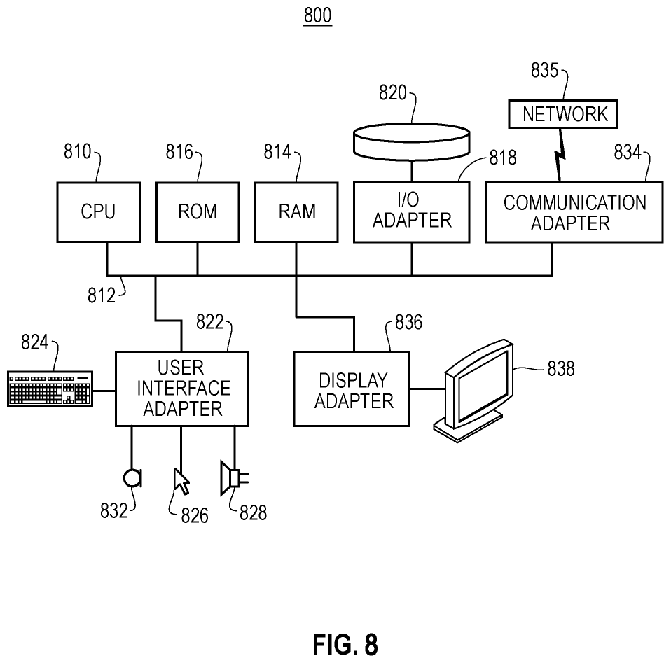

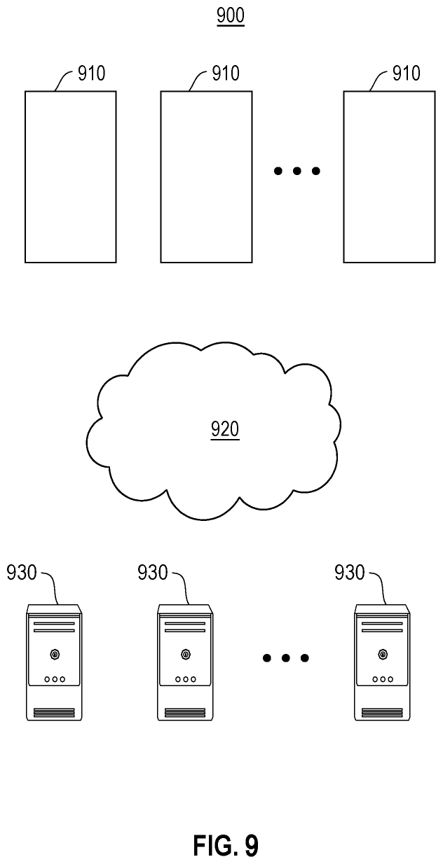

FIG. 4 illustrates a block diagram of a process 400 for using a computing device to train a NN to recognize features in univariate or multivariate time series data, according to one embodiment. In one embodiment, in block 410, process 400 receives, by a computing device (from computing node 510, FIG. 5, hardware and software layer 660, FIG. 6, processing system 700, FIG. 7, system 800, FIG. 8, system 900, FIG. 9, etc.), variate time series data. In block 420, process 400 further provides receiving, by the computing device, results associated with the variate time series data. In block 430, process 400 further provides determining, by the computing device, an anchor (e.g., anchor (x^{ref}), FIG. 3) of the variate time series data. In block 440, process 400 additionally provides determining, by the computing device, one or more portions of the variate time series data which lead to a positive result (e.g., xₖ^{pos}, FIG. 3). In block 450, process 400 further provides determining, by the computing device, one or more portions of the variate time series data which lead to a negative result (xₖ^{neg}, FIG. 3). In block 460, process 400 further provides training, by the computing device, a NN to interpret results of future variate time series data based upon the anchor, the one or more portions of the variate time series data which lead to the positive result, and the one or more portions of the variate time series data which lead to the negative result.

In one embodiment, process 400 may further include the feature that the variate time series data is univariate time series data or multivariate time series data.

In one embodiment, process 400 may additionally include the feature that the neural network is further trained to represent any portion of the time series data based upon one or more combinations of the anchor, the one or more portions of the variate time series data which lead to the positive result, the one or more portions of the variate time series data which lead to the negative result. In one embodiment, process 400 may further include the feature that one or more distances between the one or more portions of the variate time series data which leads to the positive result, the one or more portions of the variate time series data which lead to the negative result, and the anchor is used in training the NN.

In one embodiment, process 400 may still additionally include the feature that determining the anchor includes a selection of a random sub-interval of a corresponding length for each variate time series data object in a training batch of multiple variate time series data objects.

In one embodiment, process 400 may yet additionally include determining the anchor includes selection of a local variance based selection protocol that systematically sweeps through the variate time series data in entirety and produces a sequence of anchors, selected one at a time across batches, for each variate time series object included in a training batch of multiple variate time series data objects.

In one embodiment, process 400 may further include the feature that the positive result and the negative result are determined using a random selection protocol which selects variate time series object indices randomly with replacement from a set of all variate time series data objects available for training.

In one embodiment, process 400 may still further include the feature that the positive result is determined using a label-aware random selection protocol, which uses a restricted set of those variate time series object indices whose labels match a label of the variate time series data object from which the anchor is determined, and performs a random selection with replacement from the restricted set; and the negative result is determined using a label-aware random selection protocol, which uses a restricted set of those variate time series object indices whose labels do not match a label of the variate time series data object from which the anchor is determined, and that performs a random selection with replacement from the restricted set.

It is understood in advance that although this disclosure includes a detailed description of cloud computing, implementation of the teachings recited herein are not limited to a cloud computing environment. Rather, embodiments of the present embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines (VMs), and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed and automatically, without requiring human interaction with the service's provider.

Broad network access: capabilities are available over a network and accessed through standard mechanisms that promote use by heterogeneous, thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned and, in some cases, automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported, thereby providing transparency for both the provider and consumer of the utilized service.

Service Models are as follows:

Software as a Service (SaaS): the capability provided to the consumer is the ability to use the provider's applications running on a cloud infrastructure. The applications are accessible from various client devices through a thin client interface, such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is the ability to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is the ability to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is a service oriented with a focus on statelessness, low coupling, modularity, and semantic interoperability. At the heart of cloud computing is an infrastructure comprising a network of interconnected nodes.

Referring now to FIG. 5, an illustrative cloud computing environment 550 is depicted. As shown, cloud computing environment 550 comprises one or more cloud computing nodes 510 with which local computing devices used by cloud consumers, such as, for example, personal digital assistant (PDA) or cellular telephone 554A, desktop computer 554B, laptop computer 554C, and/or automobile computer system 554N may communicate. Nodes 510 may communicate with one another. They may be grouped (not shown) physically or virtually, in one or more networks, such as private, community, public, or hybrid clouds as described hereinabove, or a combination thereof. This allows the cloud computing environment 550 to offer infrastructure, platforms, and/or software as services for which a cloud consumer does not need to maintain resources on a local computing device. It is understood that the types of computing devices 554A-N shown in FIG. 5 are intended to be illustrative only and that computing nodes 510 and cloud computing environment 550 can communicate with any type of computerized device over any type of network and/or network addressable connection (e.g., using a web browser).

Referring now to FIG. 6, a set of functional abstraction layers provided by the cloud computing environment 550 (FIG. 5) is shown. It should be understood in advance that the components, layers, and functions shown in FIG. 6 are intended to be illustrative only and embodiments are not limited thereto. As depicted, the following layers and corresponding functions are provided:

Hardware and software layer 660 includes hardware and software components. Examples of hardware components include: mainframes 661; RISC (Reduced Instruction Set Computer) architecture based servers 662; servers 663; blade servers 664; storage devices 665; and networks and networking components 666. In some embodiments, software components include network application server software 667 and database software 668.

Virtualization layer 670 provides an abstraction layer from which the following examples of virtual entities may be provided: virtual servers 671; virtual storage 672; virtual networks 673, including virtual private networks; virtual applications and operating systems 674; and virtual clients 675.

In one example, a management layer 680 may provide the functions described below. Resource provisioning 681 provides dynamic procurement of computing resources and other resources that are utilized to perform tasks within the cloud computing environment. Metering and pricing 682 provide cost tracking as resources are utilized within the cloud computing environment and billing or invoicing for consumption of these resources. In one example, these resources may comprise application software licenses. Security provides identity verification for cloud consumers and tasks as well as protection for data and other resources. User portal 683 provides access to the cloud computing environment for consumers and system administrators. Service level management 684 provides cloud computing resource allocation and management such that required service levels are met. Service Level Agreement (SLA) planning and fulfillment 685 provide pre-arrangement for, and procurement of, cloud computing resources for which a future requirement is anticipated in accordance with an SLA.

Workloads layer 690 provides examples of functionality for which the cloud computing environment may be utilized. Examples of workloads and functions which may be provided from this layer include: mapping and navigation 691; software development and lifecycle management 692; virtual classroom education delivery 693; data analytics processing 694; transaction processing 695; and for using a computing device to train a NN to recognize features in univariate or multivariate time series data processing 696 (see, e.g., process 400, FIG. 4, system 700, FIG. 7, system 800, FIG. 8). As mentioned above, all of the foregoing examples described with respect to FIG. 7 are illustrative only, and the embodiments are not limited to these examples.

It is reiterated that although this disclosure includes a detailed description on cloud computing, implementation of the teachings recited herein are not limited to a cloud computing environment. Rather, the embodiments may be implemented with any type of clustered computing environment now known or later developed.

FIG. 7 is a network architecture of a system 700 for using a computing device to train a NN to recognize features in univariate or multivariate time series data processing, according to an embodiment, according to an embodiment. As shown in FIG. 7, a plurality of remote networks 702 are provided, including a first remote network 704 and a second remote network 706. A gateway 701 may be coupled between the remote networks 702 and a proximate network 708. In the context of the present network architecture 700, the networks 704, 706 may each take any form including, but not limited to, a LAN, a WAN, such as the Internet, public switched telephone network (PSTN), internal telephone network, etc.

In use, the gateway 701 serves as an entrance point from the remote networks 702 to the proximate network 708. As such, the gateway 701 may function as a router, which is capable of directing a given packet of data that arrives at the gateway 701, and a switch, which furnishes the actual path in and out of the gateway 701 for a given packet.

Further included is at least one data server 714 coupled to the proximate network 708, which is accessible from the remote networks 702 via the gateway 701. It should be noted that the data server(s) 714 may include any type of computing device/groupware. Coupled to each data server 714 is a plurality of user devices 716. Such user devices 716 may include a desktop computer, laptop computer, handheld computer, printer, and/or any other type of logic-containing device. It should be noted that a user device 716 may also be directly coupled to any of the networks in some embodiments.

A peripheral 720 or series of peripherals 720, e.g., facsimile machines, printers, scanners, hard disk drives, networked and/or local storage units or systems, etc., may be coupled to one or more of the networks 704, 706, 708. It should be noted that databases and/or additional components may be utilized with, or integrated into, any type of network element coupled to the networks 704, 706, 708. In the context of the present description, a network element may refer to any component of a network.

According to some approaches, methods and systems described herein may be implemented with and/or on virtual systems and/or systems, which emulate one or more other systems, such as a UNIX® system that emulates an IBM® z/OS environment, a UNIX® system that virtually hosts a MICROSOFT® WINDOWS® environment, a MICROSOFT® WINDOWS® system that emulates an IBM® z/OS environment, etc. This virtualization and/or emulation may be implemented through the use of VMWARE® software in some embodiments.

FIG. 8 shows a representative hardware system 800 environment associated with a user device 716 and/or server 714 of FIG. 7, in accordance with one embodiment. In one example, a hardware configuration includes a workstation having a central processing unit 810, such as a microprocessor, and a number of other units interconnected via a system bus 812. The workstation shown in FIG. 8 may include a Random Access Memory (RAM) 814, Read Only Memory (ROM) 816, an I/O adapter 818 for connecting peripheral devices, such as disk storage units 820 to the bus 812, a user interface adapter 822 for connecting a keyboard 824, a mouse 826, a speaker 828, a microphone 832, and/or other user interface devices, such as a touch screen, a digital camera (not shown), etc., to the bus 812, communication adapter 834 for connecting the workstation to a communication network 835 (e.g., a data processing network) and a display adapter 836 for connecting the bus 812 to a display device 838.

In one example, the workstation may have resident thereon an operating system, such as the MICROSOFT® WINDOWS® Operating System (OS), a MAC OS®, a UNIX® OS, etc. In one embodiment, the system 400 employs a POSIX® based file system. It will be appreciated that other examples may also be implemented on platforms and operating systems other than those mentioned. Such other examples may include operating systems written using JAVA®, XML, C, and/or C++ language, or other programming languages, along with an object oriented programming methodology. Object oriented programming (OOP), which has become increasingly used to develop complex applications, may also be used.

FIG. 9 is a block diagram illustrating a distributed system 900 for using a computing device to train a NN to recognize features in univariate or multivariate time series data processing, according to one embodiment. In one embodiment, the system 900 includes client devices 910 (e.g., mobile devices, smart devices, computing systems, etc.), a cloud or resource sharing environment 920 (e.g., a public cloud computing environment, a private cloud computing environment, a data center, etc.), and servers 930. In one embodiment, the client devices 910 are provided with cloud services from the servers 930 through the cloud or resource sharing environment 920.

One or more embodiments may be a system, a method, and or a computer program product at any possible technical detail level of integration. The computer program product may include a computer readable storage medium (or media) having computer readable program instructions thereon for causing a processor to carry out aspects of the present embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (MI)), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the :Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the embodiments for various embodiments with various modifications as are suited to the particular use contemplated.

What is claimed is:

1. A method of using a computing device to train a neural network to recognize features in variate time series data, the method comprising:
receiving, by a computing device, variate time series data;
receiving, by the computing device, results associated with the variate time series data;
determining, by the computing device, an anchor of the variate time series data;
determining, by the computing device, one or more portions of the variate time series data which lead to a positive result;
determining, by the computing device, one or more portions of the variate time series data which lead to a negative result; and
training, by the computing device, a neural network to interpret results of future variate time series data based upon the anchor, the one or more portions of the variate time series data which lead to the positive result, and the one or more portions of the variate time series data which lead to the negative result.

2. The method of claim 1, wherein the variate time series data is univariate time series data or multivariate time series data.

3. The method of claim 2, wherein the neural network is further trained to represent any portion of the time series data based upon one or more combinations of the anchor, the one or more portions of the variate time series data which lead to the positive result, the one or more portions of the variate time series data which lead to the negative result.

4. The method of claim 1, wherein one or more distances between the one or more portions of the variate time series data which leads to the positive result, the one or more portions of the variate time series data which lead to the negative result, and the anchor is used in training the neural network.

5. The method of claim 1, wherein determining the anchor comprises a selection of a random sub-interval of a corresponding length for each variate time series data object in a training batch of multiple variate time series data objects.

6. The method of claim 1, wherein determining the anchor comprises selection of a local variance based selection protocol that systematically sweeps through the variate time series data in entirety and produces a sequence of anchors, selected one at a time across batches, for each variate time series object included in a training batch of multiple variate time series data objects.

7. The method of claim 1, wherein the positive result and the negative result are determined using a random selection protocol which selects variate time series object indices randomly with replacement from a set of all variate time series data objects available for training.

8. The method of claim 1, wherein:
the positive result is determined using a label-aware random selection protocol, which uses a restricted set of those variate time series object indices whose labels match a label of the variate time series data object from which the anchor is determined, and performs a random selection with replacement from the restricted set; and
the negative result is determined using a label-aware random selection protocol, which uses a restricted set of those variate time series object indices whose labels do not match a label of the variate time series data object from which the anchor is determined, and that performs a random selection with replacement from the restricted set.

9. A computer program product for training a neural network to recognize features in variate time series data, the computer program product comprising a computer readable storage medium having program instructions embodied therewith, the program instructions executable by a processor to cause the processor to:
receive, by the processor, variate time series data;
receive, by the processor, results associated with the variate time series data;
determine, by the processor, an anchor of the variate time series data;
determine, by the processor, one or more portions of the variate time series data which lead to a positive result;
determine, by the processor, one or more portions of the variate time series data which lead to a negative result; and
train, by the processor, a neural network to interpret results of future variate time series data based upon the anchor, the one or more portions of the variate time series data which lead to the positive result, and the one or more portions of the variate time series data which lead to the negative result.

10. The computer program product of claim 9, wherein the variate time series data is univariate time series data or multivariate time series data.

11. The computer program product of claim 10, wherein the neural network is further trained to represent any portion of the time series data based upon one or more combinations of the anchor, the one or more portions of the variate time series data which lead to the positive result, the one or more portions of the variate time series data which lead to the negative result.

12. The computer program product of claim 9, wherein one or more distances between the one or more portions of the variate time series data which leads to the positive result, the one or more portions of the variate time series data which lead to the negative result, and the anchor is used in training the neural network.

13. The computer program product of claim 9, wherein determining the anchor comprises one of:
selection of a random sub-interval of a corresponding length for each variate time series data object in a training batch of multiple variate time series data objects; or
selection of a local variance based selection protocol that systematically sweeps through the variate time series data in entirety and produces a sequence of anchors, selected one at a time across batches, for each variate time series object included in a training batch of multiple variate time series data objects.

14. The computer program product of claim 9, wherein the positive result and the negative result are determined using a random selection protocol which selects variate time series object indices randomly with replacement from a set of all variate time series data objects available for training.

15. The computer program product of claim 9, wherein the positive result is determined using a label-aware random selection protocol, which uses a restricted set of those variate time series object indices whose labels match a label of the variate time series data object from which the anchor is determined, and performs a random selection with replacement from the restricted set.

16. The computer program product of claim 9, wherein the negative result is determined using a label-aware random selection protocol, which uses a restricted set of those variate time series object indices whose labels do not match a label of the variate time series data object from which the anchor is determined, and that performs a random selection with replacement from the restricted set.

17. An apparatus comprising:
a memory configured to store instructions; and
a processor configured to execute the instructions to:
receive variate time series data;
receive results associated with the variate time series data;
determine an anchor of the variate time series data;
determine one or more portions of the variate time series data which lead to a positive result;
determine one or more portions of the variate time series data which lead to a negative result; and
train a neural network to interpret results of future variate time series data based upon the anchor, the one or more portions of the variate time series data which lead to the positive result, and the one or more portions of the variate time series data which lead to the negative result.

18. The apparatus of claim 17, wherein the variate time series data is univariate time series data or multivariate time series data.

18. The apparatus of claim 17, wherein the neural network is further trained to represent any portion of the time series data based upon one or more combinations of the anchor, the one or more portions of the variate time series data which lead to the positive result, the one or more portions of the variate time series data which lead to the negative result.

19. The apparatus of claim 16, wherein one or more distances between the one or more portions of the variate time series data which leads to the positive result, the one or more portions of the variate time series data which lead to the negative result, and the anchor is used in training the neural network.

20. The apparatus of claim 16, wherein:
determining the anchor comprises one of:
selection of a random sub-interval of a corresponding length for each variate time series data object in a training batch of multiple variate time series data objects; or
selection of a local variance based selection protocol that systematically sweeps through the variate time series data in entirety and produces a sequence of anchors, selected one at a time across batches, for each variate time series object included in a training batch of multiple variate time series data objects; and
the positive result and the negative result are determined using a random selection protocol which selects variate time series object indices randomly with replacement from a set of all variate time series data objects available for training; or
the positive result is determined using a label-aware random selection protocol, which uses a restricted set of those variate time series object indices whose labels match a label of the variate time series data object from which the anchor is determined, and performs a random selection with replacement from the restricted set, and the negative result is determined using a label-aware random selection protocol, which uses a restricted set of those variate time series object indices whose labels do not match a label of the variate time series data object from which the anchor is determined, and that performs a random selection with replacement from the restricted set.
